(19) United States
(12) Patent Application Publication
(10) Pub. No.: US 2008/0181246 A1
(43) Pub. Date: Jul. 31, 2008

(54) DATA-PACKET PROCESSING METHOD IN NETWORK SYSTEM

(75) Inventors: Wei-Pin Chen, Taipei (TW); Yun-Fei Chao, Taipei (TW)

Correspondence Address: KIRTON AND MCCONKIE, 60 EAST SOUTH TEMPLE,, SUITE 1800, SALT LAKE CITY, UT, 84111, US

(73) Assignee: VIA TECHNOLOGIES, INC., Taipei (TW)

(21) Appl. No.: 11/952,887

(22) Filed: Dec. 7, 2007

(30) Foreign Application Priority Data
Jan. 29, 2007 (TW) 096103255

(51) Int. Cl. H04L 12/56

(52) U.S. Cl. 370/412

(57) ABSTRACT

A data-packet processing method is used in a network system. The network system includes a buffer for optionally storing a data packet to be transferred, and the method includes steps of: detecting a remaining space of the buffer; prohibiting a first type of data packet and a second type of data packet from being stored into the buffer when the remaining space of the buffer is equal to or less than a first threshold; allowing the first type of data packet and the second type of data packet to be stored into the buffer when the remaining space of the buffer is greater than a second threshold; and allowing the first type of data packet to be stored into the buffer while prohibiting the second type of data packet from being stored into the buffer when the remaining space of the buffer is greater than the first threshold but equal to or less than the second threshold.

### FIELD OF THE INVENTION

The present invention relates to a data-packet processing method, and more particularly to a data-packet processing method for use in a network system.

### BACKGROUND OF THE INVENTION

One kind of network system, e.g. a local area network as shown in FIG. 1, consists of a plurality of stations 101˜105 and a hub 10 connected to the stations 101˜105. The stations 101˜105 can be personal computers or computer servers, which transfer/receive data packets to/from one another via the hub 10. As a hub is substantially a Level 1 device, it merely functions for connection of stations other than management of data packets. In other words, the stations may arbitrary transfer data via the hub by sharing the bandwidth. The more the stations work through the hub, the slower the operational speed of the network system due to the limitation of bandwidth.

Switch hubs which are Level 2 devices are thus developed for transferring and managing data packets among stations in order to maintain the operational speed of the network system at a satisfactory level. A switch hub not only allows data packets to be transferred thereby but also functions for screening data packets and allocating the data packets.

A switch hub and its operational principle are illustrated in FIG. 2A and FIG. 2B. For example, the switch hub 2 is connected thereto a first station 201 and a second station 202. The switch hub 2 includes a controlling and processing unit 20, a switch device 21, a buffer 22 and a storage unit 23. When the first station 201 is to transfer a data packet to the second station 202 via the switch hub 2, the controlling and processing unit 20 checks the contents from Level 2 to Level 7 (L2˜L7 contents) of the data packet to classify the data packet. The controlling and processing unit 20 corresponds the L2˜L7 contents to a specified action according to a data-packet classifying table 232, which is briefly depicted in FIG. 2B. For example, when the L2˜L7 contents 0 indicates that the data packet is a transmission control protocol (TCP) packet, the action 0 can be a retransmit action when the buffer 22 has no further space for the coming data packet. That is, the TCP data packet is requested to issue a retransmit signal to the station 201 via the controlling and processing unit 20 and the switch device 21 in order to have the data packet successfully transmitted. In another example, when the L2˜L7 contents 1 indicates that the data packet is a user datagram protocol (UDP) packet, the action 1 can be a discard (not retransmit) action when the buffer 22 has no further space for the coming data packet. If there is space available in the buffer 22 to receive the coming data packet, the data packet will be stored into the buffer 22 after being classified according to its L2˜L7 contents and wait to be transmitted to a destination station, e.g. the station 202. The destination station is determined according to a destination address recorded in the transmitted data packet and an address correlation table 231 stored in the storage unit 23. On the other hand, when the buffer 22 has no further space for the coming data packet, the data packet will be discarded directly no matter which type the data packet is. As mentioned above, a TCP packet will be retransmitted after being discarded, while a UDP packet will be lost forever once being dicarded.

An example of the UDP data is video/audio data transmitted for a video conference in a local area network. The transmission of such data is required to be real time and the data are not allowed to be retransmitted. If the video conference is being held while the there are a number of data packets being transmitted in the network, the buffer is likely to become full soon, particularly when there are many data being transmitted and repetitively retransmitted. In the mean time, the UDP data that are supposed not to be retransmitted may be discarded to an unacceptable degree, resulting in intermittent images and voices.

### SUMMARY OF THE INVENTION

Therefore, the present invention provides a data-packet processing method which manages the receipt of data packets in the buffer in a more practical manner.

A data-packet processing method for transferring a data packet in a network system includes steps of: determining a type of the data packet to be transferred; determining a storage state of a buffer where the data packet is to be temporarily stored before transferring; storing the data packet into the buffer if the storage state of the buffer is a packet-accepting storage state; and prohibiting the data packet from being stored into the buffer if the storage state of the buffer is a packet-rejecting storage state; wherein the packet-accepting storage state and packet-rejecting storage state of the buffer vary with the type of the data packet.

A data-packet processing method is used in a network system. The network system includes a buffer for optionally storing a data packet to be transferred, and the method includes steps of: detecting a remaining space of the buffer; prohibiting a first type of data packet and a second type of data packet from being stored into the buffer when the remaining space of the buffer is not greater than a first threshold; allowing the first type of data packet and the second type of data packet to be stored into the buffer when the remaining space of the buffer is greater than a second threshold; and allowing the first type of data packet to be stored into the buffer while prohibiting the second type of data packet from being stored into the buffer when the remaining space of the buffer is greater than the first threshold but not greater than the second threshold.

A network system for transferring a data packet from a first station includes a buffer coupled to the first station for receiving and temporarily storing the data packet when the buffer is at a packet-accepting storage state; a controller coupled to the first station and the buffer for determining a type of the data packet and whether the buffer is at the packet-accepting storage state or a packet-rejecting storage state, and prohibiting the data packet from being stored into the buffer when the buffer is at the packet-rejecting storage state; and a switching device coupled to the buffer and a plurality of stations for transferring the data packet stored in the buffer to one of the stations, wherein the packet-accepting storage state and packet-rejecting storage state of the buffer vary with the type of the data packet.

### BRIEF DESCRIPTION OF THE DRAWINGS

The above contents of the present invention will become more readily apparent to those ordinarily skilled in the art after reviewing the following detailed description and accompanying drawings, in which:

FIG. 1 is a schematic diagram illustrating a local area network system transferring data via a conventional hub;

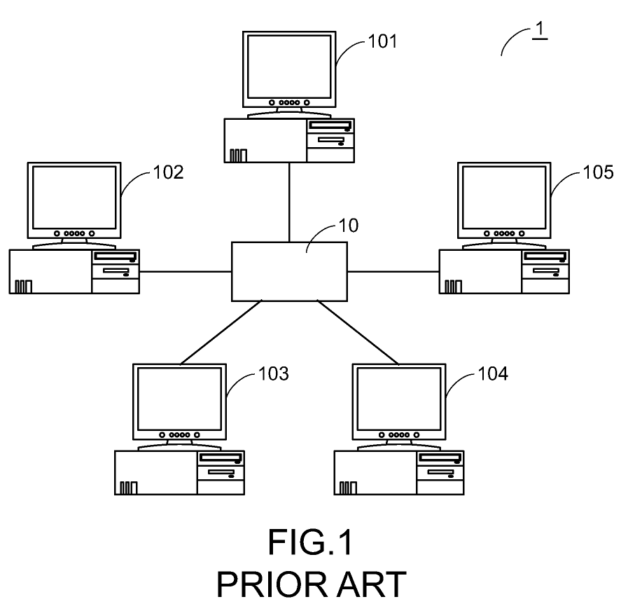

FIG. 2A is a block diagram schematically showing a switch hub for transferring data in a network system according to prior art;

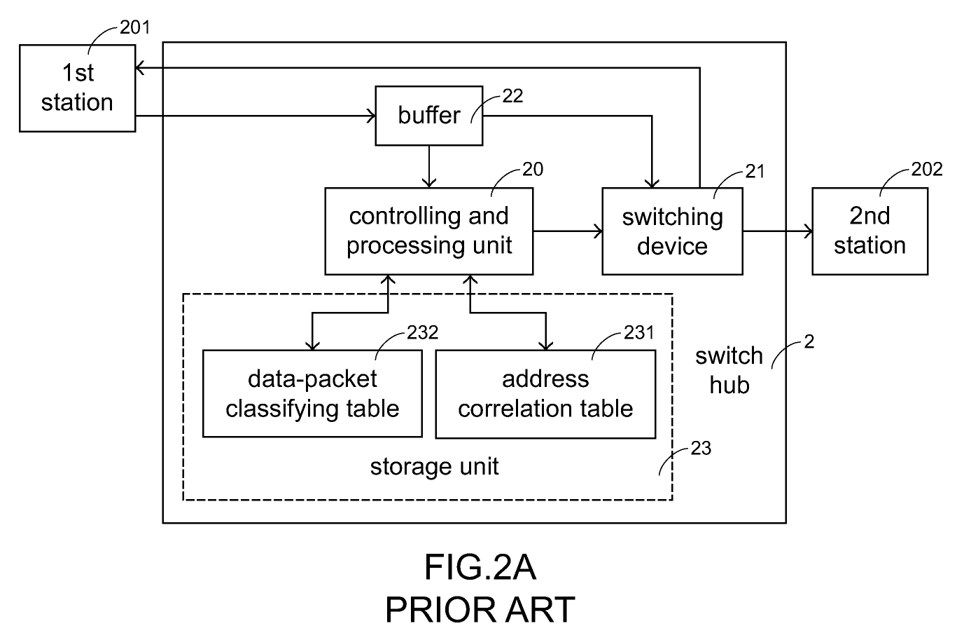

FIG. 2B is a schematic data-packet classifying table used in the switch hub of FIG. 2A;

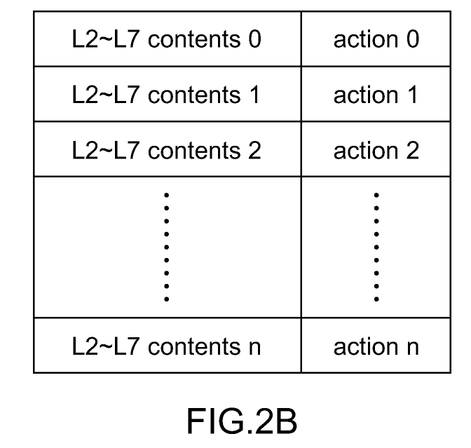

FIG. 3A is a block diagram schematically showing a switch hub for transferring data in a network system according to an embodiment of the present invention;

FIG. 3B is a schematic data-packet classifying table used in the switch hub of FIG. 3A;

FIG. 4 is a flowchart illustrating a data-packet processing method according to an embodiment of the present invention; and

FIG. 5 is a flowchart illustrating an example of the data-packet processing method according to an embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

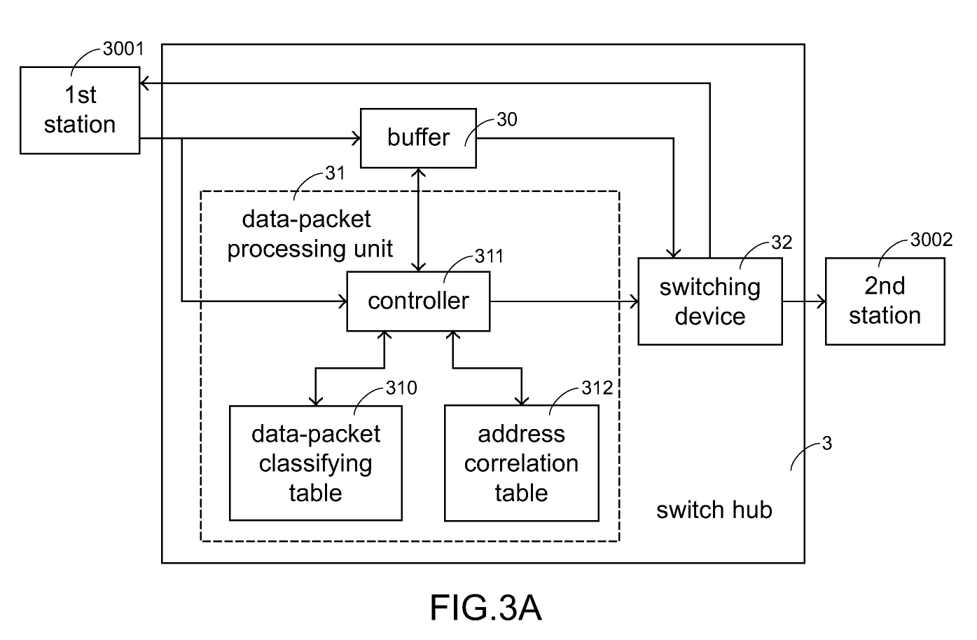

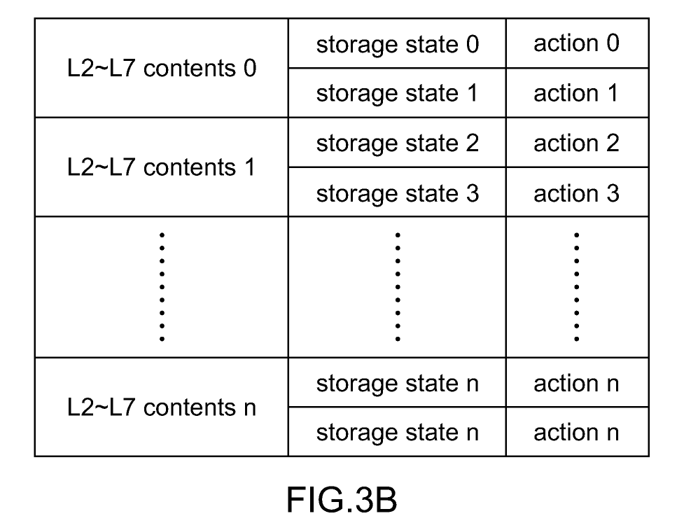

Please refer to FIG. 3A, which illustrates a network system for processing data packets according to an embodiment of the present invention. In the network system, a plurality of stations, e.g. a first station 3001 and a second station 3002, are coupled to a switch hub 3 and transfer data to one another via the switch hub 3. The switch hub 3 includes a buffer 30, a data-packet proceeding unit 31 and a switching device 32. The buffer 30 is used for temporarily storing a data packet which is transmitted from one of the stations, e.g. the first station 3001, and waiting to be transferred to another station, e.g. the second station 3002, through the switching device 32 by the data-packet processing unit 31. The buffer 30, depending on its occupied space (or remaining space) and corresponding to each type of data packet, is classified into a plurality of storage states. For example, each type of data packet corresponds to two storage states. As illustrated in a data-packet classifying table of FIG. 3B, when a data packet received from the first station 3001 includes L2˜L7 contents 0, it indicates that the data packet is a first type of data packet, and then the state of the buffer 30 associated with the first type of data packet is checked. If the buffer 30 is at the storage state 0, an action 0 is adopted. On the contrary, if the buffer 30 is at the storage state 1, an action 1 is adopted. One of the actions 0 and 1, e.g. action 0, is set to allow the first type of data packet to be temporarily stored in the buffer 30 while the other action, e.g. action 1, is set to disallow the first type of data packet to be temporarily stored in the buffer 30. Likewise, when a data packet received from the first station 3001 includes L2˜L7 contents 1, which indicates that the data packet is a second type of data packet, and if the buffer 30 associated with the second type of data packet is at the storage state 2, an action 2 is adopted. On the contrary, if the buffer 30 is at the storage state 3, an action 3 is adopted. One of the actions 2 and 3, e.g. action 2, makes the second type of data packet temporarily stored in the buffer 30 while the other, e.g. action 3, does not. The other parts of the table can be derived in a similar way, and is not to be redundantly described here.

The classification of data packets is performed by the data-packet processing unit 31. The data-packet processing unit 31 includes the aforementioned data-packet classifying table 310, a controller 311 and an address correlation table 312. After a data packet is sent by the first station 3001 and has been classified as a first type of data packet according to the classifying table 310, the controller 311 further checks the occupied space (or remaining space) of the buffer 30 in order to determine the storage state of the buffer 30. If the buffer 30 is at the storage state 0, the controller 311 issues a control signal to have the first type of data packet stored into the buffer 30. On the other hand, if the buffer 30 is at the storage state 1, the controller 311 issues a control signal to prohibit the first type of data packet from being stored into the buffer 30. Likewise, if a second type of data packet is received and if the buffer 30 is at the storage state 2, the controller 311 issues a control signal to have the second type of data packet stored into the buffer 30. On the contrary, if the buffer 30 is at the storage state 3, the controller 311 issues a control signal to prohibit the second type of data packet from being stored into the buffer 30. Afterwards, by checking the destination address of the data packet stored in the buffer 30 and referring to the address correlation table 312, the controller 311 determines a destination where the data packet is to be transmitted, e.g. the second station 3002.

The first type of data packet and the second type of data packet may have different transmission protocols. For example, the first type of data packet can be a UDP data packet while the second type of data packet can be a TCP data packet. Accordingly, the actions 1 and 3, which disallow the data packet to be stored into the buffer 30, include a discard action for the UDP data packet and a retransmit action for the TCP data packet.

On the other hand, the storage states of the buffer 30 are distinguished according to the comparison of the occupied space (or remaining space) of the buffer 30 with one or more thresholds. For example, for transmitting a UDP data packet, the storage states of the buffer 30 include the storage state 0, which represents the remaining space of the buffer 30 is greater than a first threshold, and the storage state 1, which represents the remaining space of the buffer 30 is equal to or less than the first threshold. Likewise, for transmitting a TCP data packet, the storage states of the buffer 30 include the storage state 2, which represents the remaining space of the buffer 30 is greater than a second threshold, and the storage state 3, which represents the remaining space of the buffer 30 is equal to or less than the second threshold. Further action rules can be applied to a variety of data packets in a similar manner.

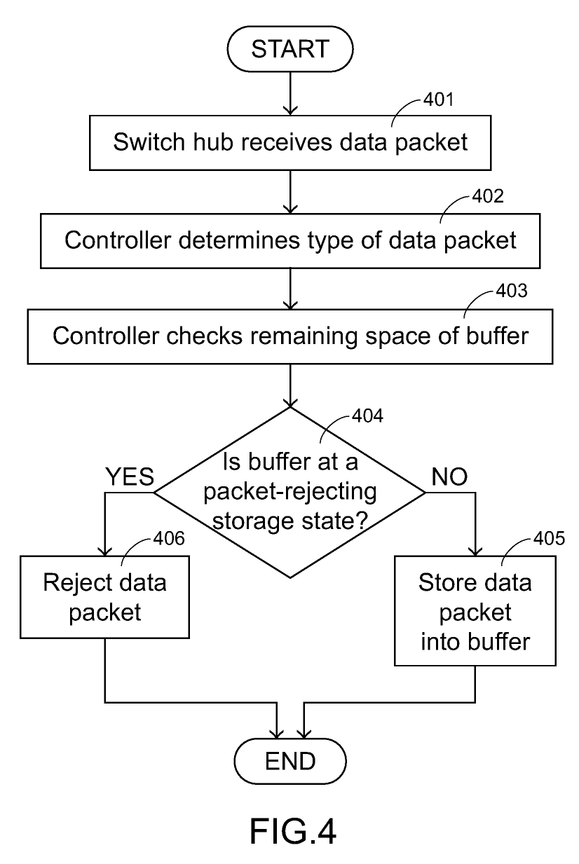

The data-processing method as described above is summarized in the flowchart of FIG. 4. When the switch hub receives a data packet (Step 401), the type of the data packet is determined by the controller according to data-packet classifying table (Step 402). Meanwhile, the controller further checks a remaining space of the buffer (Step 403). If the buffer is not at a packet-rejecting storage state, i.e. at a packet-accepting storage sate (Step 404), e.g. the storage state 0 or 2, the data packet is allowed to be stored into the buffer (Step 405). If the buffer is at a packet-rejecting storage state (Step 404), e.g. the storage state 1 or 3, the data packet is prohibited from being stored into the buffer (Step 406).

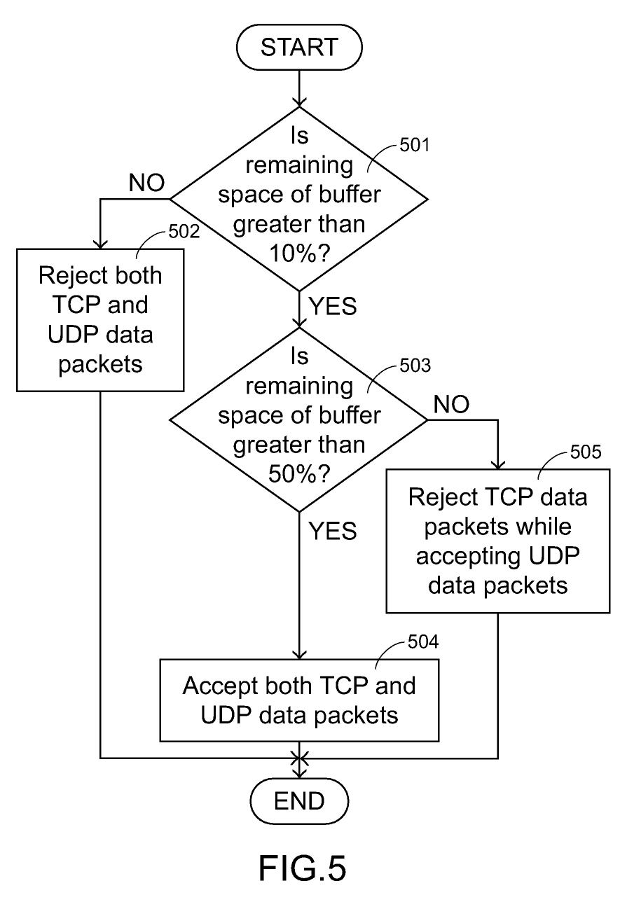

It is understood to those skilled in the art that the first threshold and second threshold are settable depending on practical requirements. For example, since TCP data packets can be repetitively retransmitted, for assuring of the smooth transmission of UDP data packets which will be lost forever if not successfully transmitted, it is desirable to reserve more buffer space for UDP data packets. Therefore, the second threshold set for prohibiting the entrance of TCP data packets into the buffer is much higher than the first threshold for UDP data packets. As illustrated in FIG. 5, the first threshold is set to be 10% while the second threshold is set to be 50%. Assuming the remaining space of the buffer is 5%, which is less than 10% (Step 501), at a specified time point, neither TCP data packets nor DUP data packets are allowed to be stored into the buffer (Step 502). On the contrary, if the remaining space of the buffer is greater than 10%, the buffer is further checked to see if its remaining space is greater than 50% (Step 503). If the remaining space is greater than 50%, e.g. 80%, it means that there would be sufficient space for storing both TCP data packets and DUP data packets (Step 504). Otherwise, when the remaining space is greater than 10% but less than 50%, e.g. 25%, the remaining space is to be reserved for UDP data packets, so TCP data packets are rejected and will be retransmitted later.

To sum up, the present switch hub can flexibly determine whether a data packet is to be stored into a buffer or discarded before the buffer is full because a threshold is set for monitoring the remaining space of the buffer. Furthermore, by giving different thresholds for different types of data packets, data packets can be optimally processed.

While the invention has been described in terms of what is presently considered to be the most practical and preferred embodiments, it is to be understood that the invention needs not to be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A data-packet processing method for transferring a data packet in a network system, comprising steps of:
determining a type of the data packet to be transferred;
determining a storage state of a buffer where the data packet is to be temporarily stored before transferring;
storing the data packet into the buffer if the storage state of the buffer is a packet-accepting storage state; and
prohibiting the data packet from being stored into the buffer if the storage state of the buffer is a packet-rejecting storage state;
wherein the packet-accepting storage state and packet-rejecting storage state of the buffer vary with the type of the data packet.

2. The method according to claim 1 wherein the type of the data packet is determined according to contents of Level 2 to Level 7 (L2˜L7 contents) recorded in the data packet.

3. The method according to claim 1 wherein the storage state of the buffer is determined according to a remaining space of the buffer.

4. The method according to claim 3 wherein the packet-rejecting storage state of the buffer for a user datagram protocol (UDP) packet is entered when the remaining space of the buffer is equal to or less than a first threshold, and the packet-rejecting storage state of the buffer for a transmission control protocol (TCP) packet is entered when the remaining space of the buffer is equal to or less than a second threshold different from the first threshold.

5. The method according to claim 4 wherein the first threshold is lower than the second threshold.

6. The method according to claim 4 wherein the first threshold is 10% and the second threshold is 50%.

7. A data-packet processing method in a network system, the network system including a buffer for optionally storing a data packet to be transferred, and the method comprising steps of:
detecting a remaining space of the buffer;
prohibiting a first type of data packet and a second type of data packet from being stored into the buffer when the remaining space of the buffer is equal to or less than a first threshold;
allowing the first type of data packet and the second type of data packet to be stored into the buffer when the remaining space of the buffer is greater than a second threshold; and
allowing the first type of data packet to be stored into the buffer while prohibiting the second type of data packet from being stored into the buffer when the remaining space of the buffer is greater than the first threshold but equal to or less than the second threshold.

8. The method according to claim 7 wherein the first type of data packet is a data packet which will be discarded if not successfully transmitted previously, and the second type of data packet is a data packet which will be retransmitted if not successfully transmitted previously.

9. The method according to claim 8 wherein the first type of data packet is a user datagram protocol (UDP) packet, and the second type of data packet is a transmission control protocol (TCP) packet.

10. A network system for transferring a data packet from a first station, comprising:
a buffer coupled to the first station for receiving and temporarily storing the data packet when the buffer is at a packet-accepting storage state;
a controller coupled to the first station and the buffer for determining a type of the data packet and whether the buffer is at the packet-accepting storage state or a packet-rejecting storage state, and prohibiting the data packet from being stored into the buffer when the buffer is at the packet-rejecting storage state; and
a switching device coupled to the buffer and a plurality of stations for transferring the data packet stored in the buffer to one of the stations,
wherein the packet-accepting storage state and packet-rejecting storage state of the buffer vary with the type of the data packet.

11. The network system according to claim 10 wherein the packet-accepting storage state of the buffer is determined when a remaining space of the buffer is greater than a threshold.

12. The network system according to claim 11 wherein the threshold varies with the type of the data packet.

13. The system according to claim 12 wherein a user datagram protocol (UDP) packet has the threshold lower than that of a transmission control protocol (TCP) packet.

14. The network system according to claim 10 further comprising a data-packet classifying table referred by the controller to determine an action of the controller according to L2˜L7 contents of the data packet and a storage state of the buffer.

15. The network system according to claim 14 wherein when the storage state of the buffer is the packet-accepting storage state, the action of the controller is to store the data packet into the buffer, and when the storage state of the buffer is the packet-rejecting storage state, the action of the controller is to prohibit the data packet from being stored into the buffer.

16. The network system according to claim 10 further comprising an address correlation table referred by the controller to determine a destination station among the plurality of stations, where the data packet is to be transferred.

17. The network system according to claim 10 wherein the buffer, the controller and the switching device are incorporated in a switch hub.
